(19) United States
(12) Patent Application Publication
(10) Pub. No.: US 2022/0330472 A1
(43) Pub. Date: Oct. 20, 2022

(54) DEGRADABLE AROMA PRODUCT WITH SEEDS WRAPPED THEREIN

(71) Applicant: CHIEN EN BUILDING MATERIALS CO., LTD., Taoyuan City (TW)

(72) Inventor: YUN-CHUN LO, Taoyuan City (TW)

(21) Appl. No.: 17/233,534

(22) Filed: Apr. 18, 2021

(51) Int. Cl. A01C 1/04; A01G 13/02

(52) U.S. Cl. CPC A01C 1/046; A01G 13/0262

(57) ABSTRACT

A degradable aroma product with seeds wrapped therein includes plant seeds and growth carriers coated or mixed with plant nutrients and aromatizers. The degradable aroma product may be in the form of an aroma card with the growth carriers being made of paper pulp, or alternatively, in the form of an aroma sachet with the plant seeds and the growth carriers or the aroma card wrapped in a degradable packaging bag. When the degradable aroma product has been used over a period of time and no longer produces fragrance, it can be directly buried in soil without forming any pollutant and accordingly, meets the requirement of plastic and waste reduction. Further, with the plant nutrients, the plant seeds can grow into trees, flowers or fruits more easily to enable sustainable development of healthy circle of life (i.e. the product design concept of cradle-to-cradle), carbon reduction and environmental protection.

### BACKGROUND OF THE INVENTION

### 1. Field of the Invention

The present disclosure relates to a degradable aroma product with seeds wrapped therein and in particular, to a degradable seeds and aroma sachet and a degradable seeds and aroma card.

### 2. Description of the Related Art

A closed space, such as a drawer, a closet, a shoe cabinet or a toilet room, usually has bad air quality and smells moldy. A common way to solve the above problems is to use an aroma sachet or an aroma card.

The structure of the conventional aroma sachet usually includes a packaging bag made of a non-woven fabric. And, the fillings in the conventional aroma sachet are usually plastic aroma beads containing industrial fragrances.

The structure of the conventional aroma card usually includes a thick water-absorbent card paper coated with essential oils and showing various ink-printed designs.

Sweet scents diffused from the conventional aroma sachet and aroma card provide the effect of removing bad odors and making air smell better.

### BRIEF SUMMARY OF THE INVENTION

An objective of the present disclosure is to provide a degradable aroma product with seeds wrapped therein to overcome the disadvantages of the conventional aroma sachet and the conventional aroma card, including the packaging bags and fillings of the aroma sachet made of non-degradable non-woven fabrics and plastic aroma beads, which are not environment-friendly.

In the event the conventional aroma sachet is directly discarded or buried in soil after it has been used over a long time and no longer diffuses sweet scents, the non-degradable non-woven fabric packaging bag and plastic aroma beads thereof are not degradable in soil and have the risk of contaminating the soil to cause environmental pollution. Sometimes, the used conventional aroma sachet can be burned instead of discarding or burying it in soil.

While the used conventional aroma sachet can be burnt to avoid the problem of soil pollution, the burning aroma sachet will inevitably cause air pollution because the plastic aroma beads filled in the aroma sachet would produce toxin chemical compounds, such as dioxin. Some people suggest an alternative way of processing the waste aroma sachets by directly dumping them into sea. However, residual particles of the plastic aroma beads remained in sea life would severely affect the marine ecology.

The conventional aroma card does not have the problem of plastic aroma beads, but it is no longer usable after having been used over a period of time. For instance, the used conventional aroma card just could not grow into trees naturally.

To achieve at least the above objective, the degradable aroma product wrapped with seeds according to one aspect of the present disclosure is in the form of an aroma sachet, which includes a plurality of plant seeds, a plurality of growth carriers and a packaging bag. The growth carriers respectively have a substrate layer and a coating layer. The coating layer is applied on at least one surface of the substrate layer, and has plant nutrients and aromatizers contained therein. The packaging bag wraps the plant seeds and the growth carriers therein.

In an embodiment, the substrate layers are selected from the group consisting of softwood pellets/chips, wood chips and tree barks.

In an embodiment, the growth carriers respectively have a granular size ranged from 1 to 20 mm.

In an embodiment, the aromatizers are selected from the group consisting of essential oils, spices and herbal distillates.

In an embodiment, the aromatizers are essential oils, and the essential oils are extracted from floral plants and/or herbal plants.

In an embodiment, the plant seeds are selected from the group consisting of acacia seeds, lilium brownie seeds, roselle seeds, cosmos seeds and red quinoa seeds.

In an embodiment, a ratio, by weight, of the plant seeds to the growth carriers is 1:1˜20.

In another embodiment, the degradable aroma product with seeds wrapped therein in the form of an aroma sachet further includes an amount of fertilizers, and the packaging bag also wraps the fertilizers therein.

In an embodiment, a ratio, by weight, of the plant seeds to the growth carriers to the fertilizers is 1:1˜10:1˜6.

To achieve at least the above objective, the degradable aroma product with seeds wrapped therein according to another aspect of the present disclosure is in the form of an aroma card, which includes an integrally molded mixture made up of a plurality of plant seeds, an amount of paper pulp, an amount of plant nutrients and an amount of aromatizers.

In an embodiment of the aroma card, a ratio, by weight, of the plant seeds to the paper pulp to the plant nutrients to the aromatizers is 1:1˜10:1˜6:1˜3.

In an embodiment of the aroma card, the mixture further includes an amount of fertilizers.

In an embodiment of the degradable aroma product with seeds wrapped therein according to another aspect of the present disclosure, it further includes a packaging bag for wrapping the aroma card therein.

The degradable aroma product with seeds wrapped therein according to the first aspect of the present disclosure is also briefly referred to as the degradable seeds and aroma sachet or simply aroma sachet, which includes a degradable packaging bag, which is used to wrap plant seeds and growth carriers coated with plant nutrients and aromatizers instead of the conventionally known plastic aroma beads. When the degradable aroma product (or aroma sachet) with seeds wrapped therein is no longer useful, i.e. when the aromatizers wrapped in the packaging bag are used up, the waste aroma sachet can be directly buried in soil to meet the requirement of waste and plastic reduction without forming any pollutant. In addition, the plant nutrients in the packaging bag facilitate easier growth of the plant seeds into trees or flowers to enable sustainable development of healthy circle of life (i.e. the product design concept of cradle-to-cradle), environmental protection and carbon reduction.

The degradable aroma product with seeds wrapped therein according to the second aspect of the present disclosure is also briefly referred to as the degradable seeds and aroma card or simply aroma card, which includes plant seeds, paper pulp, plant nutrients and aromatizers. When the degradable aroma product (or aroma card) with seeds wrapped therein is no longer useful, i.e. when the aromatizers wrapped in the aroma card are used up, the waste aroma card can be directly buried in soil to meet the requirement of waste and plastic reduction without forming any pollutant.

In addition, the plant nutrients in the aroma card facilitate easier growth of the plant seeds into trees or flowers to enable sustainable development of healthy circle of life (i.e. the product design concept of cradle-to-cradle), environmental protection and carbon reduction.

### BRIEF DESCRIPTION OF THE DRAWINGS

FIG. 1 is a schematic view of a degradable seeds and aroma sachet according to a first embodiment of the present disclosure.

FIG. 2 is a schematic sectional view of a growth carrier included in the degradable seeds and aroma sachet of FIG. 1.

FIG. 3 is a schematic view of a degradable seeds and aroma sachet according to a second embodiment of the present disclosure.

### DETAILED DESCRIPTION OF THE INVENTION

To facilitate understanding of the objects, characteristics and effects of this present disclosure, embodiments together with the attached drawings for the detailed description of the present disclosure are provided. It is noted the present disclosure can be implemented or applied in other embodiments, and many changes and modifications in the described embodiments can be carried out without departing from the spirit of the disclosure, and it is also understood that the preferred embodiments are only illustrative and not intended to limit the present disclosure in any way.

### First Embodiment: Degradable Seeds and Aroma Sachet 10

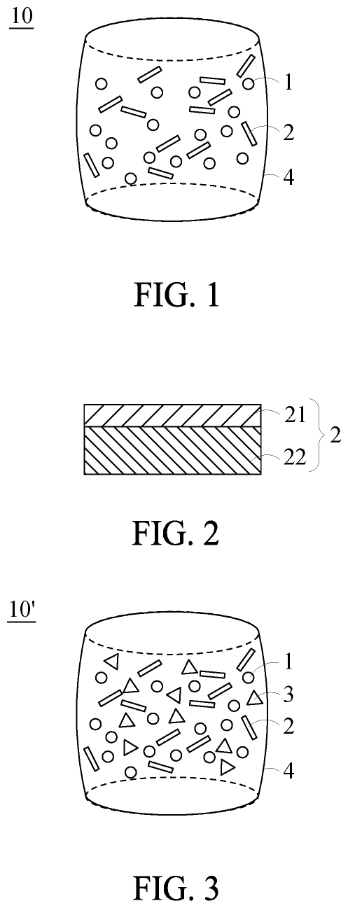

Please refer to FIG. 1, in which a degradable seeds and aroma sachet 10 according to a first embodiment of the present disclosure is schematically shown; and to FIG. 2, in which a growth carrier 2 included in the degradable seeds and aroma sachet 10 of FIG. 1 is schematically shown. In the first embodiment, the degradable seeds and aroma sachet 10 includes a plurality of plant seeds 1, a plurality of growth carriers 2 and a packaging bag 4. As can be seen in FIG. 1, the packaging bag 4 wraps the plant seeds 1 and the growth carrier 2 therein. As can be seen in FIG. 2, the growth carriers 2 respectively include a coating layer 21 and a substrate layer 22; and the coating layer 21 is applied on at least one surface of the substrate layer 22.

The plant seeds 1 may include one or more species of flower, tree or fruit seeds. In the case of flower seeds, some examples include lilium brownie seeds, roselle seeds and cosmos seeds. In the case of tree seeds, acacia seed is one example. And, in the case of fruit seeds, red quinoa seed is one example. In other words, the plant seeds 1 can be selected from the group consisting of acacia seeds, lilium brownie seeds, roselle seeds and red quinoa seeds. The degradable seeds and aroma sachet 10 encloses the plant seeds 1 therein and can be used as a fragrance bag, allowing scents from the flower seeds, the tree seeds or the fruit seeds permeates surrounding air. When the plant seeds 1 in the degradable seeds and aroma sachet 10 no longer produce scents, they can still grow into trees, flowers or fruits.

According to an operable embodiment, different species of plant seeds 1 can be filled in the degradable seeds and aroma sachet 10. However, for all the plant seeds 1 in the degradable seeds and aroma sachet 10 to grow well after the bag 10 is no longer usable, it is preferable for each of the degradable seeds and aroma sachet 10 to include species of plant seeds 1 that require similar growth conditions.

The substrate layers 22 of the growth carriers 2 can be selected from the group consisting of softwood pellets/chips, wood chips and tree barks. The substrate layers 22 prepared with softwood pellets/chips, wood chips and/or tree barks can sufficiently absorb plant nutrients contained in the coating layers 21 to ensure constant growth of the plant seeds 1. Sources of the softwood pellets/chips, wood chips and tree barks can be softwoods or other hardwoods. In the case of softwoods, some examples include, but not limited to, pine, dragon spruce, cedar, fir, larch, Douglas fir, tsuga, cypress, California redwood and Japanese yew. Further, the substrate layers 22 of the growth carriers 2 are not particularly limited to any specific configuration, so long as they are degradable and can sufficiently absorb plant nutrients and aromatizers. Therefore, other materials, such as corncobs, paper/pulp and dried plant materials, may also be used as the substrate layers 22.

The growth carriers 2 or the substrate layers 22 thereof are also not particularly limited to any specific shape; they can be grains, cuboids or polyhedrons. In the case of grains, the growth carriers 2 preferably respectively have a granular size ranged from 1 to 20 mm to enable easy wrapping of the growth carriers 2 in the packaging bag 4. On the other hand, in the case of cuboids or polyhedrons, the growth carriers 2 preferably respectively have a longest side ranged from 1 to 20 mm.

The packaging bag 4 is made of a degradable material, such as a degradable non-woven fabric. In the event a non-degradable material, such as the conventional non-woven fabric, is used to make the packaging babe 4 while the things wrapped therein, i.e. the plant seeds 1 and the growth carriers 2, are degradable, the used degradable seeds and aroma sachet 10 is still not suitable for directly discarding or burying in soil even if it indeed reduces some degree of plastic material and waste. This is because different non-degradable materials (i.e. the non-woven fabrics) would very possibly cause soil pollution if they are not sorted before being burnt. In the present disclosure, degradable materials, such as degradable non-woven fabrics, or other bio-degradable environment-friendly materials, such as degradable paper/fabrics and degradable plastics, such as polylactic acid (PLA), are selected for making the packaging bag 4. Other suitable materials may also be used.

With the degradable packaging bag 4 and the degradable things wrapped therein (i.e. the plant seeds 1 and the growth carriers 2), the used degradable seeds and aroma sachet 10 of the present disclosure can be directly discarded to soil. The used degradable seeds and aroma sachet 10 in the soil would be decomposed by soil microorganisms eventually to achieve the effects of zero-pollution, plastic and waste reduction and create sustainable environmental protection and preservation.

Please refer to FIG. 2. The coating layer 21 is applied on at least one surface of the substrate layer 21, and has plant nutrients and aromatizers contained therein.

More specifically, the coating layer 21 can be applied on one of many surfaces of the substrate layer 22, or be applied on a plurality of surfaces of the substrate layer 22. In the present disclosure, it is not always necessary to have the coating layer 21, so long as the growth carriers 2 can have the plant nutrients and aromatizers existed therein. For instance, the plant nutrients and aromatizers can be blended with the substrate layer 22 to form a mixture, which can be used to make aroma cards that will be described latter.

The plant nutrients can be commercially available plant nutrients without being particularly limited thereto.

The aromatizers can be non-restrictively selected from the group consisting of essential oils, spices, and herbal distillates. It is preferable to utilize the essential oils, spices and herbal distillates self-produced and sold by small farmers to realize the concept of circular economy (i.e. the production concept of from place of origin to factory).

The amount of aromatizers to be used for each degradable seeds and aroma sachet 10 are not particularly specified and are adjustable according to the diffusion rate of the aromas through air and the intended service life of the degradable seeds and aroma sachet 10. In a preferred embodiment, the aromatizers are essential oils extracted from floral plants and/or herbal plants. Further, the aromatizers can be synthetically produced or naturally extracted without being specifically limited thereto.

Further, to facilitate easy growth of the plant seeds 1, a ratio, by weight, of the plant seeds 1 to the growth carriers 2 is preferably 1:1˜20. When the cost factor is further taken into consideration, the ratio, by weight, of the plant seeds 1 to the growth carriers 2 is preferably 1:1˜10. To strive for the most desirable state, the ratio, by weight, of the plant seeds 1 to the growth carriers 2 is 1:1˜6.

### Second Embodiment: Degradable Seeds and Aroma Sachet 10′

Please refer to FIG. 3, in which a degradable seeds and aroma sachet 10′ according to a second embodiment of the present disclosure is schematically shown. In the second embodiment, the degradable seeds and aroma sachet 10′ includes a plurality of plant seeds 1, a plurality of growth carriers 2, an amount of fertilizers 3, and a packaging bag 4. The packaging bag 4 wraps the plant seeds 1, the growth carriers 2 and the fertilizers 3 therein. Since the plant seeds 1, the growth carriers 2 and the packaging bag 4 are similar to those in the first embodiment shown in FIGS. 1 and 2, they are not repeatedly described.

In the second embodiment, the degradable seeds and aroma sachet 10′ further includes an amount of fertilizers 3, which is also wrapped in the packaging bag 4, to facilitate easy growth of the plant seeds 1. In the present disclosure, the fertilizers 3 can be commercially available fertilizers without being particularly limited to any specific type and are adjustable according to the species of the plant seeds 1.

To facilitate easy growth of the plant seeds 1, a ratio, by weight, of the plant seeds 1 to the growth carriers 2 to the fertilizers 3 is preferably 1:1˜10:1˜6. Further, when the cost factor is taken into consideration, the ratio, by weight, of the plant seeds to the growth carriers 2 to the fertilizers 3 is 1:6:4.

### Practical Manner of Using the Second Embodiment

Prepare a packaging bag made of a non-woven fabric; put naturally dried acacia seeds, growth carriers coated with plant nutrients/nutrient solutions and aromatizers/essential oils, and an amount of fertilizers in the packaging bag; and seal the packaging bag to obtain a degradable seeds and aroma sachet 10′ according to the second embodiment of the present disclosure. When the aromatizers/essential oils no longer diffuse fragrant scents after the degradable seeds and aroma sachet 10′ has been used over a period of time, the whole sachet 10′ can be directly discarded or buried in soil. And, growth of the plant seeds 1 with time can be observed.

### A Variant Embodiment: Degradable Seeds and Aroma Card

A degradable seeds and aroma card (not shown) according to a variant embodiment of the present disclosure can be made through a method as described below and includes a plurality of plant seeds, a plurality of growth carriers containing plant nutrients and aromatizers, and an amount of fertilizers. Since the plant seeds, the plant nutrients, the aromatizers and the fertilizers are similar to those in the first and the second embodiment, they are not repeatedly described. It is noted, however, the growth carriers for the degradable seeds and aroma card respectively have a substrate layer made of paper pulp, such as recyclable/renewable paper pulp.

To make the degradable seeds and aroma card, first blend and stir acacia seeds to be used as the plant seeds, recyclable/renewable paper pulp to be used as the paper pulp, some nutrient solutions to be used as the plant nutrients, and essential oils to be used as the aromatizers to obtain a mixture. Then, pour the mixture into a mold and let it dry at a temperature between 40 and 85° C. for 30 minutes to 4 hours, so that the mixture is integrally molded without damaging the plant seeds. Thereafter, the integrally molded mixture is cut into different shapes and sizes to complete a plurality of degradable seeds and aroma cards (or hang tags). When the essential oils no longer diffuse fragrant scents after the degradable seeds and aroma card has been used over a period of time, the whole card can be directly discarded or buried in soil. And, growth of the plant seeds with time can be observed.

Preferably, when forming the above mixture, a ratio, by weight, of the plant seeds to the paper pulp to the plant nutrients to the aromatizers is 1:1˜10:1˜6:1˜3. Further, it is desirable to add some amount of fertilizers to the mixture. And, a ratio, by weight, of the plant seeds to the fertilizers is preferably 1:1˜6.

In another operable embodiment, the packaging bag described in the first and the second embodiment can be used to wrap one or more degradable seeds and aroma cards therein to provide a degradable seeds and aroma sachet containing one or more aroma cards.

When the degradable aroma product with wrapped seeds according to the present disclosure in the form of the aroma sachet 10, 10′ no longer produces any fragrant scent after the aroma sachet 10, 10′ has been used over a period of time, the degradable aroma product or the aroma sachet 10, 10′ can be directly discarded or buried in soil to meet the requirements of zero-pollution, plastic and waste reduction and sustainable environmental protection. With the plant nutrients contained in the growth carriers, the plant seeds in the discarded or buried aroma sachet can grow into trees or flower more easily to enable sustainable development of healthy circle of life (i.e. the product design concept of cradle-to-cradle) in an environment-friendly and carbon-reduced world.

Similarly, when the degradable aroma product with seeds wrapped therein according to the present disclosure in the form of the aroma card no longer produces any sweet scent after the aroma card has been used over a period of time, the degradable aroma product or the aroma card can be directly discarded or buried in soil to meet the requirements of zero-pollution, plastic and waste reduction and sustainable environmental protection. With the plant nutrients contained in the growth carriers, the plant seeds in the discarded or buried aroma card can grow into trees or flower more easily to enable sustainable development of healthy circle of life (i.e. the product design concept of cradle-to-cradle) in an environment-friendly and carbon-reduced world.

While the present disclosure has been described by means of specific embodiments, numerous modifications and variations could be made thereto by those skilled in the art without departing from the scope and spirit of the present disclosure set forth in the claims.

What is claimed is:

1. A degradable aroma product with seeds wrapped therein in the form of an aroma sachet, comprising:
a plurality of plant seeds;
a plurality of growth carriers respectively including a substrate layer and a coating layer; and the coating layer being applied on at least one surface of the substrate layer and containing plant nutrients and aromatizers; and
a packaging bag having the plant seeds and the growth carriers wrapped therein.

2. The degradable aroma product with seeds wrapped therein according to claim 1, wherein the substrate layer is formed of a material selected from the group consisting of softwood pellets/chips, wood chips, and tree barks.

3. The degradable aroma product with seeds wrapped therein according to claim 1, wherein the growth carriers respectively have a granular size ranged from 1 to 20 mm.

4. The degradable aroma product with seeds wrapped therein according to claim 1, wherein the aromatizers are selected from the group consisting of essential oils, spices, and herbal distillates.

5. The degradable aroma product with seeds wrapped therein according to claim 4, wherein the aromatizers are essential oils extracted from floral plants and/or herb al plants.

6. The degradable aroma product with seeds wrapped therein according to claim 1, wherein the plant seeds are selected from the group consisting of acacia seeds, lilium brownie seeds, roselle seeds, cosmos seeds and red quinoa seeds.

7. The degradable aroma product with seeds wrapped therein according to claim 1, wherein a ratio, by weight, of the plant seeds to the growth carriers is 1:1˜20.

8. The degradable aroma product with seeds wrapped therein according to claim 1, further comprising an amount of fertilizers, which are also wrapped in the packaging bag.

9. The degradable aroma product with seeds wrapped therein according to claim 8, wherein a ratio, by weight, of the plant seeds to the growth carriers to the fertilizers is 1:1˜10:1˜6.

10. A degradable aroma product with seeds wrapped therein in the form of an aroma card, comprising:
an integrally molded mixture made up of a plurality of plant seeds, an amount of paper pulp, an amount of plant nutrients and an amount of aromatizers.

11. The degradable aroma product with seeds wrapped therein according to claim 10, wherein a ratio, by weight, of the plant seeds to the paper pulp to the plant nutrients to the aromatizers is 1:1˜10:1˜6:1˜3.

12. The degradable aroma product with seeds wrapped therein according to claim 10, wherein the mixture further includes an amount of fertilizers.

13. The degradable aroma product with seeds wrapped therein according to claim 11, wherein the mixture further includes an amount of fertilizers.

14. The degradable aroma product with seeds wrapped therein according to claim 10, further comprising a packaging bag for wrapping the aroma card therein.

15. The degradable aroma product with seeds wrapped therein according to claim 11, further comprising a packaging bag for wrapping the aroma card therein.

16. The degradable aroma product with seeds wrapped therein according to claim 12, further comprising a packaging bag for wrapping the aroma card therein.

17. The degradable aroma product with seeds wrapped therein according to claim 13, further comprising a packaging bag for wrapping the aroma card therein.
